(19) United States
(12) Patent Application Publication
(10) Pub. No.: US 2007/0266198 A1
(43) Pub. Date: Nov. 15, 2007

(54) Method of Managing a Distributed Storage System

(75) Inventor: Laurent Pierre Francois Bousis, Zaventem (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/575,171

(22) PCT Filed: Sep. 1, 2005
(86) PCT No.: PCT/IB05/52866

§ 371 Date: Mar. 13, 2007

(30) Foreign Application Priority Data
Sep. 13, 2004 (EP) 04104408.2

(51) Int. Cl. G06F 3/06; G06F 12/00

(52) U.S. Cl. 711/4; 711/112

(57) ABSTRACT

The invention describes a method of managing a distributed storage system (1) comprising a number of storage devices (D, D₁, D2, D3, . . . , Dₙ) on a network (N) wherein, in an election process to elect one of the storage devices (D, D), D2, D3, . . . , Dₙ) as a master storage device to control the other storage devices (D, D₁, D₂, D₃, . . . , Dₙ, the storage devices (D, D₁, D₂, D₃, . . . , Dₙ) exchange parameter information (2, 2′) in a dialog to determine which of the storage devices (D, D₁, D₂, D₃, . . . , Dₙ) has a maximum value of a certain parameter, and the storage device (D, D₁, D₂, D₃, . . . , Dₙ) with the maximum parameter value is elected as the current master storage device for a subsequent time interval during which the other storage devices (D, D₁, D2, D₃, . . . , Dₙ) assume the status of dependent storage devices (D, D₁, D₂, D₃, . . . , Dₙ).

### FIELD OF THE INVENTION

The invention relates to a method for managing a distributed storage system comprising a number of storage devices.

The invention further relates to a storage device for use in a distributed storage system.

The invention further relates to a computer program product directly loadable into the memory of a programmable storage device for use in a distributed storage system.

### BACKGROUND OF THE INVENTION

Distributed storage systems are used to store data, typically large amounts of data, over a number of storage devices which are usually connected together on a network. In a typical distributed storage system, one device—which may be a mainframe computer, personal computer, workstation etc.—usually acts as a controlling device to keep track of the memory or storage capacity available on a number of other dependent devices, which may be other workstations, personal computers etc., and to record which data or content is stored on which device. The controlling device is usually the most powerful machine, i.e. the one with the most processing power or storage space. However, when this controlling device runs out of storage space, content will have to be transferred to a dependent device that still has available storage space. This introduces additional network transfer and limits the available bandwidth of the network. Also, if the controlling device should fail for some reason, the distributed storage system will be out of order for the length of time required to repair or replace the controlling device and to retrieve or reconstruct—insofar as this is possible—the data records maintained on the original controlling device. Such a repair process must be carried out manually, and can be a time-consuming and expensive process. Additional expense and delay can arise if any users of such a distributed storage system are not able to access required data as long as the controlling device is out of order.

From the document U.S. Pat. No. 4,528,624 is known a system for managing a storage system in which a central host keeps track, in a central record, of the available storage capacity in a number of peripheral storage devices. Data to be stored is allocated space on one or more of the peripheral storage devices, and the central record is updated accordingly. This system has the disadvantage mentioned above that, if the central host fails, the storage system as a whole is rendered useless, since it is the central host which keeps track of what is stored where.

### OBJECT AND SUMMARY OF THE INVENTION

Therefore, an object of the present invention is to provide a robust and inexpensive method for managing a distributed storage system.

To this end, the present invention provides a method of managing a distributed storage system comprising a number of storage devices on a network, wherein, in an election process to elect one of the storage devices as a master storage device to control the other storage devices, the storage devices exchange status and/or parameter information in a dialog to determine which of the storage devices has a most appropriate value of a certain parameter, and the storage device with the most appropriate parameter value is elected as the current master storage device for a subsequent time interval during which the other storage devices assume the status of dependent storage devices.

In an election process according to the present invention, the storage devices of the network exchange information in the form of signals to determine which one of the storage devices is most suitable to assume master storage device status. The election dialog follows a pre-defined protocol in which a storage device requests and/or supplies information regarding storage device status and/or parameter value. Any storage device with master storage device status can request status and/or parameter information from another storage device. In response to such a request, a storage device supplies the necessary information. In the event that more than one storage device has master storage device status, the value of the parameter is used to decide which of these storage devices should retain its master storage device status. The storage device with the most appropriate value, e.g. a “maximum” value or a “minimum” value, depending on the parameter type, ultimately retains its master storage device status, while the other storage devices switch their status from master to “slave”, or dependent status. The storage device elected in this manner to be the master storage device will retain this status for a following time interval, until it should fail, or until its parameter value is exceeded by that of another storage device. The terms “master” and “slave” are commonly used when referring to a controlling and a dependent device respectively, and are therefore also used in the following.

The status information exchanged between two storage devices can be either one of “master” or “slave”. The parameter information might be the value of any suitable parameter, such as free memory space, processing power, available bandwidth etc. The type of parameter is preferably defined at commencement of operation of the distributed storage system, and persists throughout. A “most appropriate” value is to be understood to be “better”, while not necessarily being larger in value. For example, if the parameter exchanged between storage devices describes current CPU load, then a lower value can be interpreted to be “better” than a high value. In the case where both storage devices have equal parameter values, the decision as to which of these devices is “superior” can be randomised, in the manner of flipping a coin.

A particularly advantageous characteristic of the present invention is therefore that the entire master/slave election process is carried out in a wholly automatic manner, obviating the need for manual interaction by a user. Thus, even if the currently designated master storage device should fail for some reason, the remaining storage devices elect one of their number to assume the role of master storage device. Human interaction is therefore not needed, and disturbances or interruptions in operation of the distributed storage system can be avoided.

A storage device for use in a distributed storage system, which storage device is operate-able as a master storage device or as a dependent storage device, therefore comprises a dialog unit for entering into a dialog with any other storage devices present on the network for receiving and/or supplying status and/or parameter value information, a status determination unit for determining the subsequent status of the storage device according to parameter values received from other storage devices, and a status toggle unit for switching the status of the storage device between master storage device status and dependent storage device status.

Since any of the storage devices should be able to assume master storage device status to replace a failed master storage device, i.e. each storage device should be able to operate interchangeably as either master or slave, the storage devices on the network are preferably identical, having the same type of processor, and running the same software. In this way, a switch between master and slave status is possible at any time for any storage device.

The dependent claims and the subsequent description disclose particularly advantageous embodiments and features of the invention.

On power-up of a storage device, the storage device most preferably automatically assumes master storage device status. It follows that, when a number of storage devices of a network are simultaneously powered up or switched on, each of these storage devices will assume master storage device status. Furthermore, when a storage device is added to a distributed storage system, it will also assume master storage device status on power-up, in addition to the master storage device already controlling the distributed storage system. Since a master/slave management system presupposes that only one of the storage devices can have master storage device status, a decision must be made as to which of the storage devices retains its master storage device status.

The advantage of having a storage device automatically assume master storage device status on power-up is that a situation is avoided in which all storage devices on the network concurrently have slave or dependent storage device status, since at least one of the storage devices will have master storage device status, and, if more than one storage device has master status, the election process to decide which of these should retain its status is straightforward.

To this end, each storage device with master storage device status commences a scanning operation in which it scans the network to determine whether any other storage devices are present, and enters into a dialog with any other storage device it might locate. The dialog follows a predefined election service protocol in which the storage device issues a request signal to another storage device in order to request information from the other storage device regarding the status and/or the parameter value of the other storage device, and/or supplies an information signal describing its own status and/or its own parameter value to another storage device in response to a request signal from the other storage device. A storage device with master status establishes a list into which it can enter descriptive information regarding any other storage device with dependent or slave status. The descriptive information might be an IP address or any other suitable information. The master storage can establish this list after power-up, or might first establish the list when it detects another storage device with slave storage device status.

In the event that a first storage device with master storage device status receives status information from a second storage device, confirming that the second storage device has slave status, the first storage device augments its list of slaves with appropriate information for the second storage device. Should the second storage device reply that it also has master storage device status, the first storage device will then request a parameter value from the second storage device, following the election service protocol. If the second storage device returns a parameter value less appropriate than that of the first storage device, the first storage device augments its list of slaves by entering information describing the second storage device, while the second storage device switches to slave status. On the other hand, if the second storage device returns a parameter value more appropriate than that of the first storage device, the first storage device then clears its list of slaves of any entries that might have been present in the list, and switches its status from master to slave, whereas the second storage device augments its list of slaves with an entry for the first storage device, and continues to operate as master

After power-up, one or more storage devices act as master storage device and each such master storage device issues, preferably at regular intervals, a “heartbeat request” or non-failure signal to a failure detection unit of each slave storage device in its list of slaves. A master storage device expects a response to this request. Should the dependent storage device fail to return a response, the master storage device concludes that the slave storage device has failed, and removes this slave from its list of slaves. It may also report the failure of the slave storage device to a systems operator or controller, so that any necessary maintenance or repair work can be carried out.

Furthermore, each of the slaves or dependent storage devices expects to receive this signal or request at certain intervals from the master storage device. Should the heartbeat request fail to arrive over a predefined duration, a slave storage device then concludes that the master storage device has failed, and itself assumes master storage device status. All slave storage devices capable of detecting the absence of the heartbeat signal will therefore assume master storage device status at some time after failure of the original master storage device. Each of these storage devices, following the master/slave election protocol, now commences issuing requests for status and parameter information from the other storage devices, and supply status and/or parameter information in response to requests from the other storage devices. On the basis of the information exchanged, all but one of the storage devices will switch their status from master back to slave, leaving a single storage device to retain master status. This storage device also proceeds to issue the non-failure signal to all the slave storage devices on the network.

Any suitable parameter, such as processing power, available bandwidth etc., can be used to decide which storage device is most suitable for the status of master storage device. In a particularly preferred embodiment of the invention, the parameter information supplied by a storage device comprises an indication of the free storage capacity available on that storage device, and the storage device with the most free space will be ultimately be elected to operate as master storage device. The advantage of the master storage device having the most free storage capacity at any one time is that unnecessary network transfers are avoided, which might otherwise arise if the master storage device were to run out of storage space, thus requiring a transfer of data to slave storage device. In a preferred embodiment of the invention, the master storage device endeavours to retain its free storage capacity by allocating the storage capacity of a number of the dependent storage devices to data to be stored in the distributed storage system, so that the storage capacity of the master storage device remains greater than that of each of the dependent storage devices. Therefore, unnecessary data transfers over the network are avoided, so that available network bandwidth is not affected. The master/slave constellation will seldom have to be changed, only when, for instance, a new storage device, with greater storage capacity than the current master storage device, is added to the network, or when current the master storage device should fail.

The master storage device might also be able to relocate data from one dependent storage device to another in order to optimise the available storage capacity of the distributed storage system. In the case that the master storage device might be compelled to allocate its own storage capacity, the resulting reduction in free storage capacity might result in a subsequent loss of master status, so that this storage device no longer issues the non-failure or heartbeat signal to the other storage devices on the network, with the result that several of the other storage devices, upon detecting the absence of the heartbeat request, themselves assume master storage device status. The storage device which now has the most free storage capacity is ultimately elected to be master, following an exchange of parameter values in the master/slave election service protocol, whereas the original master storage device relinquishes its status and continues operation as a slave.

The distributed storage system can comprise any number of such storage devices as described above, where at least one, and preferably all, of the storage devices avail of a failure detection unit, so that any of the dependent storage devices with a failure detection unit can, should the necessity arise, assume master storage device status. Such a failure detection unit listens to the heartbeat request issued at intervals by the master storage device. Should this request fail to arrive for a pre-defined length of time, the failure detection unit can inform the status determination unit or the status toggle unit, so that the decision to switch from slave to master status can be made.

The modules or units of a storage device, as described above, can be realised in software or hardware or a combination of both software and hardware, as is most appropriate. The master/slave election service protocol is most preferably realised in the form of a computer program product which can be directly loaded into the memory of a programmable storage device, and where the steps of the method are performed by suitable software code portions when the computer program is run on the storage device.

Other objects and features of the present invention will become apparent from the following detailed descriptions considered in conjunction with the accompanying drawings. It is to be understood, however, that the drawings are designed solely for the purposes of illustration and not as a definition of the limits of the invention.

### BRIEF DESCRIPTION OF THE DRAWINGS

FIG. 1 shows a distributed storage system according to the invention in the form of a block diagram.

FIG. 2 is a schematic block diagram showing the elements of a storage device according to an embodiment of the invention.

FIG. 3 shows a flow chart illustrating the steps of a master/slave election protocol for a method according to the invention.

FIG. 4 is a temporal diagram illustrating steps in the election process of a master storage device according to an embodiment of the invention.

FIG. 5 is a temporal diagram illustrating steps in the election process of a master storage device according to an embodiment of the invention.

FIG. 6 is a temporal diagram illustrating steps in the election process of a master storage device according to an embodiment of the invention.

FIG. 7 is a temporal diagram illustrating the result of failure of a slave storage device according to an embodiment of the invention.

FIG. 8 is a temporal diagram illustrating the result of failure of a master storage device according to an embodiment of the invention.

### DESCRIPTION OF EMBODIMENTS

In the drawings, like numbers refer to like objects throughout.

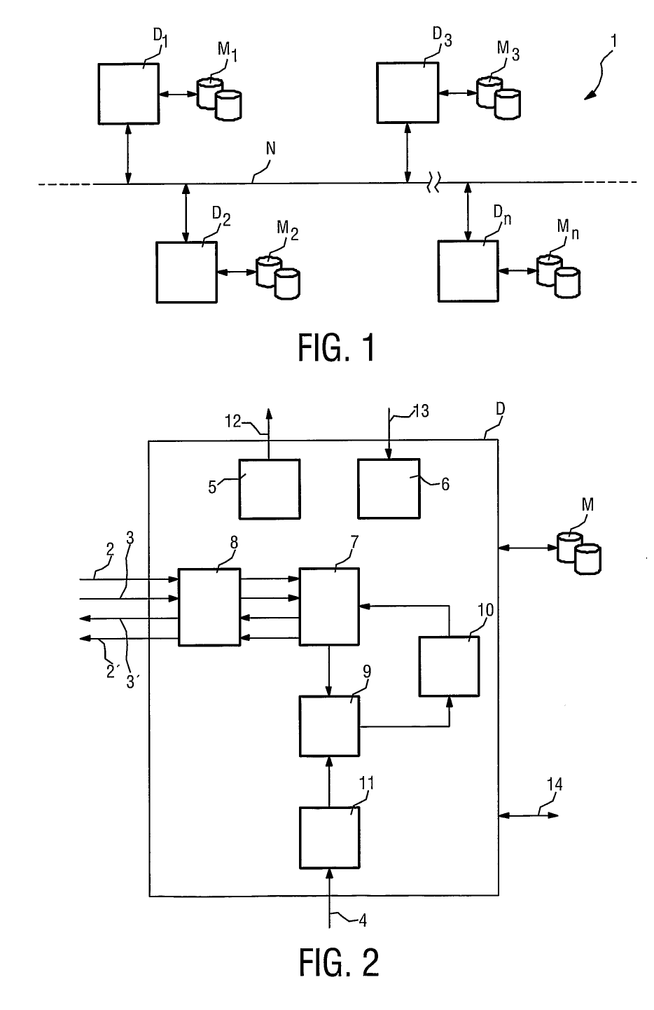

FIG. 1 shows a number of storage devices D₁, D₂, D₃, . . . , Dₙ of a distributed storage system 1 connected with each other by means of a network N. Each storage device D₁, D₂, D₃, . . . , Dₙ comprises a processing board with network connection and a hard-disk M₁, M₂, M₃, . . . , Mₙ, of variable size, and each storage device D₁, D₂, D₃, . . . , Dₙ runs the same software stack. The network N can be realised in any suitable manner, and is shown as a backbone network N in the diagram for the sake of simplicity. Each of the storage devices D₁, D₂, D₃, . . . , Dₙ in the distributed storage system 1 is capable of receiving information—i.e. signals—from any other storage device D₁, D₂, D₃, . . . , Dₙ on the network N, and is also capable of sending information to any other storage device D₁, D₂, D₃, . . . , Dₙ on the network N using some suitable bus addressing protocol, which need not be dealt with in any depth here.

A storage device D₁, D₂, D₃, . . . , Dₙ according to the invention can be used to store data to and retrieve data from an associated memory M₁, M₂, M₃, . . . , Mₙ, which might comprise one or more hard-disks, volatile memory, or even a combination of different memory types. Each storage device D₁, D₂, D₃, . . . , Dₙ is associated with its own particular memory M₁, M₂, M₃, . . . , Mₙ. Data to be stored to a memory M₁, M₂, M₃, . . . , Mₙ, of a storage device D₁, D₂, D₃, . . . , Dₙ is sent over the network N to the target storage device(s) D₁, D₂, D₃, . . . , Dₙ. Any signals controlling the storage process are also sent over the network N.

To allow any storage device D₁, D₂, D₃, . . . , Dₙ to assume the role of master storage device at any time, should the necessity arise, each storage device D₁, D₂, D₃, . . . , Dₙ will have a database containing metadata associated with content, as well as pointers to the physical location of the content on the hard-disks M₁, M₂, M₃, . . . , Mₙ. The database will also contain any settings of the distributed storage system. This database will be updated on the master storage device by the master storage device, and subsequently replicated to all slave storage devices D₁, D₂, D₃, . . . , Dₙ.

Typically, such a distributed storage system 1 is continually in operation. A storage device D₁, D₂, D₃, . . . , Dₙ may be added to the distributed storage system 1 at any time, or a storage device D₁, D₂, D₃, . . . , Dₙ might be removed for some reason, such as unsuitability, physical failure, maintenance measures etc. When a storage device D₁, D₂, D₃, . . . , Dₙ is added to the network N, the contents of the master database are replicated to the new storage device D₁, D₂, D₃, . . . , Dₙ, so that it is ready to accept new content. If a storage device D₁, D₂, D₃, . . . , Dₙ should fail, the master storage device removes from its database all metadata associated with content that was only stored on the memory of that storage device D₁, D₂, D₃, . . . , Dₙ. In the event that the master storage device should fail, one of the remaining storage devices D₁, D₂, D₃, . . . , Dₙ will be elected to master, and will remove all metadata associated to content that was only stored in the memory of the previous master.

Since storage space in a distributed storage system 1 should be allocated centrally, one of the storage devices D₁, D₂, D₃, . . . , Dₙ is elected or appointed “master” status, while the remaining storage devices D₁, D₂, D₃, . . . , Dₙ assume “slave” or dependent status, in a master/slave election dialog which will be described in more detail below. This master storage device will thereafter determine to which of the storage devices D₁, D₂, D₃, . . . , Dₙ any incoming data is to be allocated or stored, and from which storage device D₁, D₂, D₃, . . . , Dₙ particular data is to be retrieved. Furthermore, the master storage device issues, at regular intervals, a heartbeat request signal to inform the dependent storage devices D₁, D₂, D₃, . . . , Dₙ of its continued functionality or non-failure, and to request non-failure confirmation from each slave storage device D₁, D₂, D₃, . . . , Dₙ.

To interpret the signals received over the network N, and to handle the storage of data to memory and retrieval of data from memory, a storage device avails of a number of units or modules. FIG. 2 shows a storage device D, its associated memory M, and the units 5, 6, 7, 8, 9, 10, 11 of a storage device D relevant to the invention. The storage device D might comprise any number of further units, modules or user interfaces which are not pertinent to the invention, and are therefore not considered in this description.

A command issuing unit 5 allows the storage device D, when operating as master, to issue command signals 12, such as signals concerning memory allocation or data retrieval, to the other storage devices on the network. When operating as a slave, a command receiving unit 6 receives command signals 13 from the master storage device. Data 14 can be written to or read from the memory M associated with this storage device D. The memory addressing might be managed locally by the storage device D or might be managed remotely by the master storage device.

An interface unit 8 receives an incoming request signal 2 and information signal 3 from another storage device on the network, and can also send a request signal 2′ and/or information signal 3′ to another storage device. A dialog unit 7 interprets any requests 2 and information 3 received from other storage devices, and, according to the master/slave election protocol described in detail below, issues requests and supplies status and parameter information regarding this storage device D to be sent by the interface unit 8 to another storage device on the network. It also passes information to a status determination unit 9.

A failure detection unit 11 receives or “listens to” the non-failure or heartbeat signal 4 issued by the current master storage device. Should the current master storage device fail for some reason, this heartbeat signal 4 will not arrive at the failure detection unit 11. After the absence of the heartbeat signal 4 for a predetermined length of time, it is assumed that the master storage device has failed. An appropriate signal is passed to the status determination unit 9.

This status determination unit 9 decides, on the basis of information received from the dialog unit 7 and the failure detection unit 11, whether the current master/slave status should persist, or whether its status should switch from master to slave or vice versa. A status toggle unit 10 switches the status of the storage device D from “master” to “slave”, or from “slave” to “master” accordingly.

Any of the units described above, such as the dialog unit 7, status determination unit 9 and status toggle unit 10, might be realised in the form of software modules for carrying out any signal interpretation and processing.

All of the signals 2, 2′, 3, 3′, 12, 13, 14 and 4 are assumed to be transmitted in the usual manner over the network N, but are shown separately in this diagram for the sake of clarity. Furthermore, the interface between the storage device D and the network N might be any suitable network interface card or connector, so that the command issuing unit 5, the command receiving unit 6, the failure detection unit 11, and the interface unit 8 are all combined in a single interface.

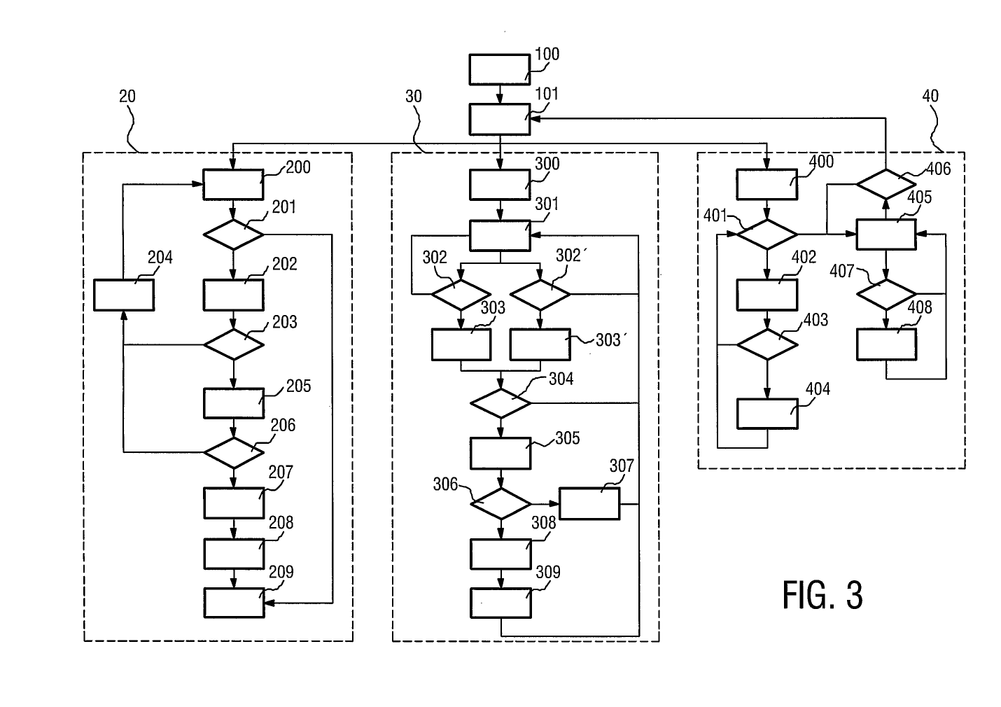

FIG. 3 shows in detail the steps of a master/slave election protocol according to the present invention. After power-up 100 of a storage device in a distributed storage system, the storage device automatically assumes master status 101. Since a storage device cannot know how many other storage devices are present on the network, and what the status or parameter values of these other storage devices are, each storage device must determine its status with respect to the other storage devices and compare parameter values if necessary. To this end, processes 20, 30, 40 for scanning the network, answering requests from other storage devices, and performing failure detection are initialised in steps 200, 300 and 400 respectively, and run in parallel on each storage device. In the following, the parameter value exchanged between storage devices is a measure of free storage capacity available on a storage device, since unnecessary data transfers over the network can be reduced by maintaining free storage capacity on the master storage device, thus avoiding unnecessary reductions in bandwidth. Clearly, any other suitable parameter value could equally well be decided upon at the outset of operation, and exchanged using the same dialog.

In the scanning process 20, the subnet or network is scanned by a first storage device in an attempt to identify the existence of an election service port of another storage device. If no other storage device is found in step 201, the first storage device concludes the scanning process 20 in step 209. If another storage device is found in step 201, the first storage device requests the status of the second storage device in step 202. In step 203, the first storage device checks to see if the second storage device is a slave. If yes, the first storage device augments its list of slaves in step 204 with descriptive information about the second storage device and returns to step 200. If the second storage device is a master, the first storage device requests its free storage space in step 205 and compares, in step 206, the free storage space of the second storage device with the own storage space.

If the second storage device has less free storage capacity than the first storage device, the first storage device augments its list of slaves with a descriptor of the second storage device in step 204 and returns to step 200. On the other hand, if the second storage device avails of more storage capacity than the first storage device, the first storage device clears its list of slaves of any entries in step 207, concedes its master status and switches to slave status in step 208, and concludes the scanning process 20 in step 209.

Parallel to the scanning process 20, an election service process 30 runs in which each storage device waits in step 301 for a request from another storage device on the network. An incoming request from a second storage device is analysed. If the state of the first storage device is requested in step 302, the first storage device returns its status (master or slave) to the second storage device in step 303. If the parameter value, in this case free storage capacity, is requested in state 302′, the first storage device returns its current free space to the second storage device in step 303′. After either of steps 303 or 303′, the first storage device checks its own status in step 304. If it is a slave, it returns to step 301 where it awaits further requests. If it is master, it requests the parameter value of the second storage device in step 305. If the second storage device returns a lower parameter value in step 306, the first storage device adds the second storage device to its list of slaves in step 307, and returns to step 301 where it listens for further requests. If, on the other hand, the parameter value returned by the second storage device in step 306 exceeds that of the first storage device, the first storage device clears its list of slaves in step 308, assumes slave status in step 309, and returns to step 301 where it resumes listening for requests from other storage devices on the network.

In the remaining process 40 for failure detection, a first storage device checks its state in step 401. If it is master, it then requests in step 402 a “heartbeat” from a second storage device in its list of slaves. If the second storage device is alive, i.e. has returned a heartbeat in step 403, the first storage device returns to step 401. On the other hand, if the second storage device fails to return a heartbeat signal in step 403, the first storage device concludes in step 404 that the second storage device has failed, and removes this second storage device from its list of slaves.

In step 401, if the first storage device determines that it is not master, it waits in step 405, for a predefined length of time, for a heartbeat request from a master storage device. In step 406, the first storage device continually compares the time already spent waiting with a predefined duration. If a heartbeat request arrives in step 407, within the specified maximum timeout, the first storage device responds to the master storage device in step 408 by sending a confirmation signal, and returns to step 405 to await further heartbeat requests. If the length of time waited equals or exceeds the predefined duration for waiting on a heartbeat request, the first storage device concludes in step 406 that the master storage device has failed, and assumes master storage device status itself in step 101.

Since other storage devices will also have concluded that the master storage device has failed, and will in turn have assumed master storage device status, the master/slave election protocol will once more elect one of the storage devices to retain its master status while the other storage devices become slave devices.

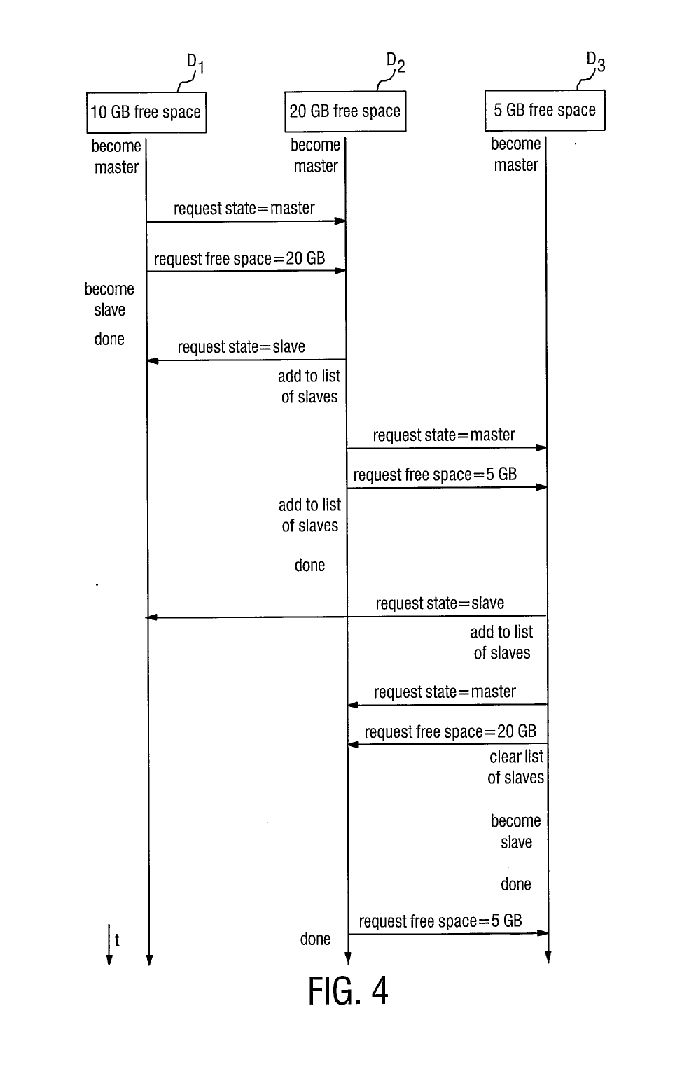

FIGS. 4-8 are temporal diagrams illustrating sequences in time, indicated by t, of steps in a master/slave election protocol as described above.

FIG. 4 shows the sequence of steps in a master/slave election protocol, in which a master storage device is elected from among a number of storage devices, all of which have master storage device status after system power-up. In this example, three devices D₁, D₂ and D₃ all initially have master storage device status and commence the scanning and master election processes described above. D₁ requests from D₂ its status and its free space. Since D₂ has more available storage capacity than D₁, D₁ subsequently switches its status to slave and concludes its scanning process. D₂ on the other hand requests status information from D₁, sees that D₁ is a slave, and augments its list of slaves with an entry for D₁. It then detects D3 and requests from it status and storage capacity information. Again, D₃ has less free storage capacity than D₂, so that D₂ augments its list of slaves with an entry for D₃. D₂ finds no further storage devices on the network and therefore concludes its scanning process and continues operation as master storage device. D₃ is still scanning the network, and detects D₁. In response to a request for status information, D₁ supplies its state, which is now “slave”. D₃ augments its list with this information and proceeds to request status information from D₂. D₂ is still master, so that D₃ is compelled to also request parameter information. On seeing that D₂ has more free storage capacity than D₃ itself, D₃ realises that it must cede its master status. It therefore clears its list of slaves, switches from master to slave status, and concludes its scanning process.

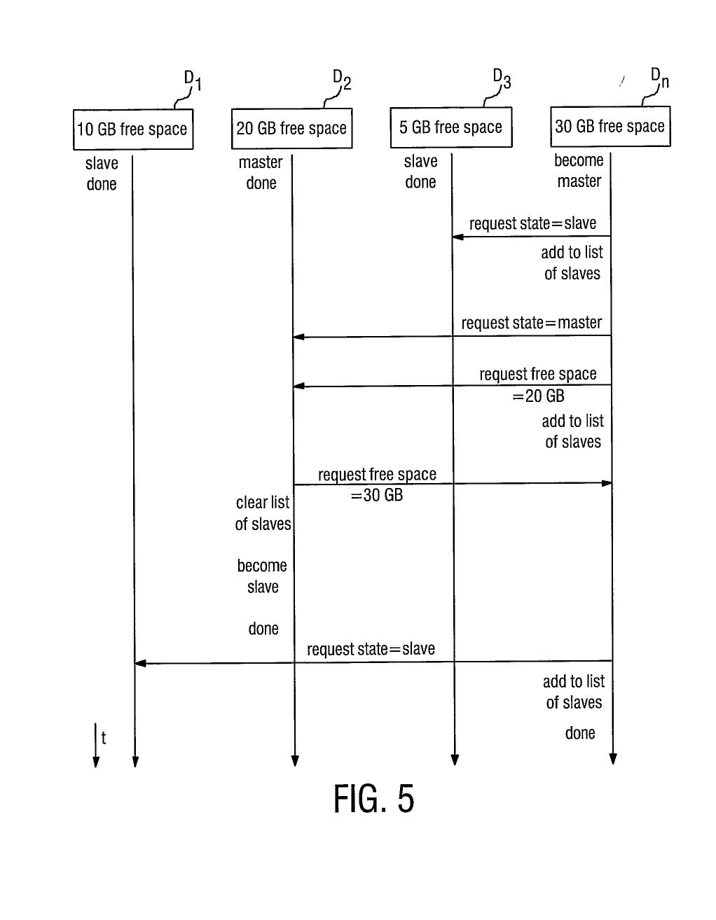

FIG. 5 illustrates the effect of adding a further storage device Dₙ to the distributed storage system comprising the three storage devices D₁, D₂, D₃ described in FIG. 4 above. The storage device D₂ is operating as master, but the newly added storage device Dₙ also has master status. This new device Dₙ automatically starts the scanning process and first locates storage device D₃, which supplies its state (slave) in response to a request from storage device Dₙ, which in turn updates its list of slaves with an entry describing. Next, the storage device Dₙ issues a request for status from storage device D₂. On learning that this storage device D₂ also has master status, storage device Dₙ asks for its free storage capacity. Since storage device D₂ has less free storage capacity (20 Gbyte), the new storage device Dₙ augments its list of slaves with an entry for storage device D₂. This exchange is followed by a request from storage device D₂ to storage device Dₙ, requesting its free storage capacity. On learning that storage device Dₙ has more free storage capacity than itself, storage device D₂ clears its list of slaves and relinquishes its master status, switching into slave status. Finally, storage device Dₙ locates the last remaining storage device D₁ on the network, and requests its state. Since storage device D₁ is operating as slave, storage device Dₙ augments its list with an appropriate entry, and concludes its scanning process.

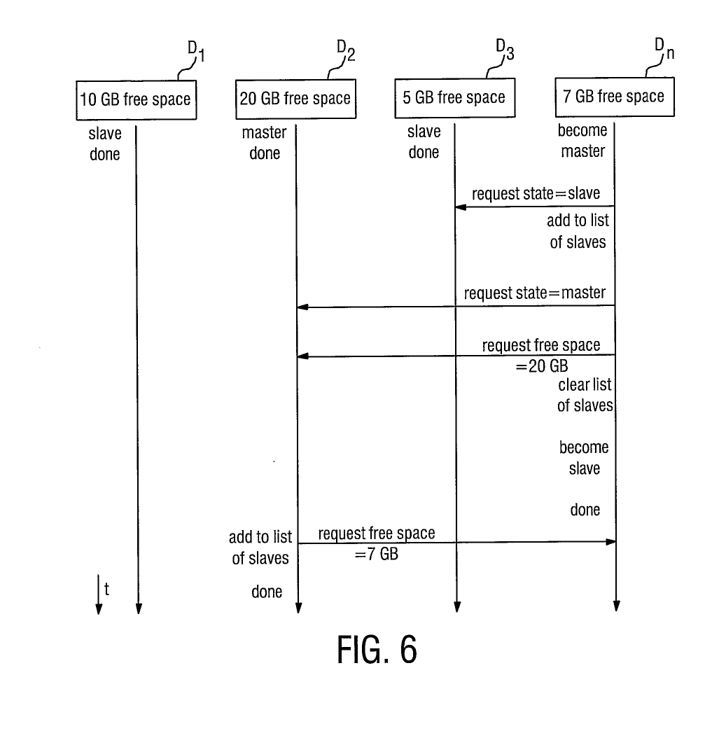

FIG. 6 shows a similar situation, but, in this case, the new storage device Dₙ has less storage capacity than the currently acting master storage device D₂. As described in FIG. 5 above, the new storage device commences the scanning process and first detects storage device D₃, adding a entry for this storage device after learning that it is a slave. Next, the new storage device Dₙ detects storage device D₂, which also has master status. An exchange of information according to the master/slave election protocol informs the new storage device Dₙ that storage device D₂ has master status and more free storage capacity than itself. Therefore, storage device D₂ clears its list of slaves and relinquishes its master status. Storage device D₂ requests the parameter value from storage device Dₙ describing its available storage capacity and augments its list of slaves with an appropriate entry, and continues to operate as master.

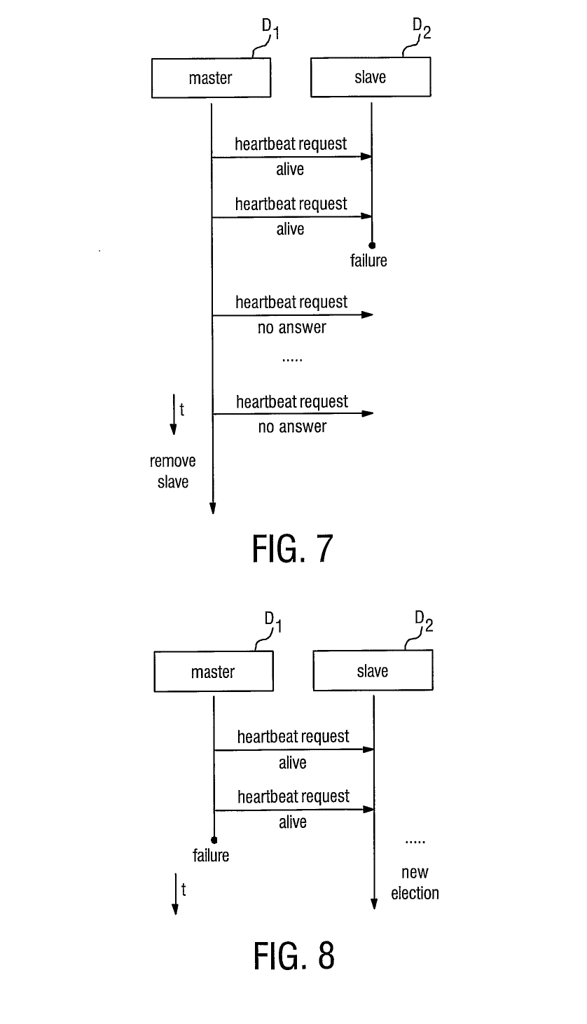

As already described, a master storage device issues heartbeat requests at intervals to all slave storage devices on a network. Each slave must respond within a certain time to such a request by returning an “alive” signal, and the response is registered by the master storage device. FIG. 7 illustrates the result of a failure to respond to a heartbeat request. Here, storage device D₁ is master, and issues heartbeat requests to all slave storage devices on the network, of which only slave storage device D₂ is shown for the sake of simplicity. As long as storage device D₂ is operating, it returns “alive” in response to the heartbeat requests from master storage device D₁. At some point, storage device D₂ fails, and is no longer able to respond to the heartbeat requests from master storage device D₁. After a number of tries without receiving any response, storage device D₁ concludes that slave storage device D₂ is no longer operational, and removes the entry describing storage device D₂ from its list of slaves.

Since the master storage device might also fail at some point during operation, a slave storage device can respond to such a failure. FIG. 8 shows an exchange of heartbeat requests and responses between a master storage device D₁ and a slave storage device D₂. At some point, master storage device D₁ fails for some reason. As a result, its heartbeat requests are no longer issued. The slave storage device D₂ continues to wait for the heartbeat requests. After a predefined length of time, it concludes that the master storage device D₁ is no longer operational, and itself assumes master status. Any other slave storage devices, not shown in the diagram for the sake of simplicity, might also assume master storage device status. Thereafter, the master/slave election service is run so that, ultimately, only one master storage device will retain master storage device status, and the remaining storage devices will resume slave status.

Although the present invention has been disclosed in the form of preferred embodiments and variations thereon, it will be understood that numerous additional modifications and variations could be made thereto without departing from the scope of the invention. For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. Method of managing a distributed storage system (1) comprising a number of storage devices (D, D₁, D₂, D₃, . . . , Dₙ) on a network (N), wherein, in an election process to elect one of the storage devices (D, D₁, D₂, D₃, . . . , Dₙ) as a master storage device to control the other storage devices (D, D₁, D₂, D₃, . . . , Dₙ) the storage devices (D, D₁, D₂, D₃, . . . , Dₙ) exchange status and/or parameter information (3, 3′) in a dialog to determine which of the storage devices (D, D₁, D₂, D₃, . . . , Dₙ) has a most appropriate value of a certain parameter, and the storage device (D, D₁, D₂, D₃, . . . , Dₙ) with the most appropriate parameter value is elected as the current master storage device for a subsequent time interval during which the other storage devices (D, D₁, D₂, D₃, . . . , Dₙ) assume the status of dependent storage devices (D, D₁, D₂, D₃, . . . , Dₙ).

2. A method as claimed in claim 1, wherein each storage device (D, D₁, D₂, D₃, . . . , Dₙ) initially assumes the status of master storage device.

3. A method as claimed in claim 2, wherein a storage device (D, D₁, D₂, D₃, . . . , Dₙ), upon assuming master storage device status, enters into a dialog with any other storage devices (D, D₁, D₂, D₃, . . . , Dₙ) present on the network (N), wherein the dialog follows a predefined election service protocol in which the storage device (D, D₁, D₂, D₃, . . . , Dₙ) issues a request signal (2′) to another storage device (D, D₁, D₂, D₃, . . . , Dₙ) in order to request information (3) from the other storage device (D, D₁, D₂, D₃, . . . , Dₙ) regarding the status and/or the parameter value of the other storage device (D, D₁, D₂, D₃, . . . , Dₙ), and/or supplies an information signal (3′) describing its own status and/or its own parameter value to another storage device (D, D₁, D₂, D₃, . . . , Dₙ) in response to a request signal (2) from the other storage device (D, D₁, D₂, D₃, . . . , Dₙ).

4. A method as claimed in claim 3, wherein, in the dialog between a first storage device (D, D₁, D₂, D₃, . . . , Dₙ) with master storage device status and a second storage device (D, D₁, D₂, D₃, . . . , Dₙ) with dependent storage device status, the first storage device (D, D₁, D₂, D₃, . . . , Dₙ) enters information regarding the second storage device (D, D₁, D₂, D₃, . . . , Dₙ) into a list established for storing entries regarding storage devices (D, D₁, D₂, D₃, . . . , Dₙ) with dependent storage device status.

5. A method as claimed in claim 3, wherein, in the dialog between two storage devices (D, D₁, D₂, D₃, . . . , Dₙ) with master storage device status, the storage device (D, D₁, D₂, D₃, . . . , Dₙ) with the less appropriate parameter value switches its status from master storage device status to dependent storage device status and clears, if present, its list of any entries regarding dependent storage devices.

6. A method as claimed in claim 1, wherein the storage device (D, D₁, D₂, D₃, . . . , Dₙ) with master storage device status issues a non-failure request (4) at regular intervals to broadcast its non-failure to any other storage devices (D, D₁, D₂, D₃, . . . , Dₙ) on the network (N) and/or to determine the non-failure of any dependent storage devices (D, D₁, D₂, D₃, . . . , Dₙ) on the network (N).

7. A method as claimed in claim 6, wherein a storage device (D, D₁, D₂, D₃, . . . , Dₙ) with dependent storage device status assumes master storage device status if the non-failure signal (4) is determined to be absent for a pre-defined duration.

8. A method as claimed in claim 1, wherein the parameter information (3, 3′) supplied by a storage device (D, D₁, D₂, D₃, . . . , Dₙ) comprises an indication of the free storage capacity available on that storage device (D, D₁, D₂, D₃, . . . , Dₙ), and the storage device (D, D₁, D₂, D₃, . . . , Dₙ) with the most free storage capacity is elected to be the current master storage device.

9. A method as claimed in claim 1, where the master storage device endeavours to retain its free storage capacity by preferably allocating the storage capacity of a number of the dependent storage devices (D, D₁, D₂, D₃, . . . , Dₙ) to data to be stored in the distributed storage system (1).

10. A storage device (D, D₁, D₂, D₃, . . . , Dₙ) for use in a distributed storage system (1), which storage device (D, D₁, D₂, D₃, . . . , Dₙ) is operate-able as a master storage device or as a dependent storage device, comprising
a dialog unit (7) for entering into a dialog with any other storage devices (D, D₁, D₂, D₃, . . . , Dₙ) present on the network (N) for receiving and/or supplying status and/or parameter value information (3, 3′); and
status determination unit (9) for determining the subsequent status of the storage device (D, D₁, D₂, D₃, . . . , Dₙ) according to parameter values (3) received from other storage devices (D, D₁, D₂, D₃, . . . , Dₙ); and
a status toggle unit (10) for switching the status of the storage device (D, D₁, D₂, D₃, . . . , Dₙ) between master storage device status and dependent storage device status.

11. A storage device (D, D₁, D₂, D₃, . . . , Dₙ) as claimed in claim 10, comprising a failure detection unit (11) for determining the absence of the non-failure signal (4) and wherein the status determination unit (9) and/or status toggle unit (10) of the storage device (D, D₁, D₂, D₃, . . . , Dₙ) are realised in such a way that the status of the storage device (D, D₁, D₂, D₃, . . . , Dₙ) is switched from dependent storage device status to master storage device status upon absence, for a pre-defined duration, of the non-failure signal (4) of a master storage device.

12. A distributed storage system (1) comprising a number of storage devices (D, D₁, D₂, D₃, . . . , Dₙ) according to claim 10.

13. A distributed storage system (1) as claimed in claim 12, wherein at least one of the storage devices (D, D₁, D₂, D₃, . . . , Dₙ) is a storage device (D, D₁, D₂, D₃, . . . , Dₙ) comprising a failure detection unit (11) for determining the absence of the non-failure signal (4) and wherein the status determination unit (9) and/or status toggle unit (10) of the storage device (D, D₁, D₂, D₃, . . . , Dₙ) are realised in such a way that the status of the storage device (D, D₁, D₂, D₃, . . . , Dₙ) is switched from dependent storage device status to master storage device status upon absence, for a pre-defined duration, of the non-failure signal (4) of a master storage device.

14. A computer program product directly loadable into the memory of a programmable storage device (D, D₁, D₂, D₃, . . . , Dₙ) for use in a distributed storage system (1), comprising software code portions for performing the steps of a method according to claim 1 when said product is run on the storage device (D, D₁, D₂, D₃, . . . , Dₙ).
